(19) United States
(12) Patent Application Publication
(10) Pub. No.: US 2008/0001879 A1
(43) Pub. Date: Jan. 3, 2008

(54) Driving method of liquid crystal display device

(75) Inventor: Tian-Yi Wu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/824,882

(22) Filed: Jul. 2, 2007

(30) Foreign Application Priority Data
Jun. 30, 2006 (TW) 95123847

(51) Int. Cl. G09G 3/36

(52) U.S. Cl. 345/88

(57) ABSTRACT

An exemplary method of driving a liquid crystal display device (LCD) (10). The LCD device includes pixel regions (105), and a light source (160) each including a pixel electrode. The driving method includes: dividing a frame period into at least three sub-frame periods, the light source emitting at least three different primary color rays in the at least three sub-frame periods respectively, and applying a data signal to each pixel electrode in each sub-frame period. The data signal comprises a constant high voltage and a constant low voltage. When the data signal is on high voltage, the corresponding primary color rays transmit through the corresponding pixel region at a constant transmission ratio. When the data signal is on low voltage, substantially no color rays transmit through. The duration of the corresponding primary color rays transmitting through the corresponding pixel region is controlled by a duty cycle of the data signal.

### FIELD OF THE INVENTION

The present invention relates to a method of driving a liquid crystal display (LCD) device, the method involving control of duty cycles of data signals in the LCD device.

### BACKGROUND OF THE INVENTION

An LCD has the advantages of portability, low power consumption, and low radiation, and has been widely used in various portable information products such as notebooks, personal digital assistants (PDAs), video cameras and the like.

FIG. 4 is an abbreviated circuit diagram of a typical LCD device 40. The LCD device 40 includes a first substrate (not shown), a second substrate (not shown) facing the first substrate, a liquid crystal layer (not shown) sandwiched between the two substrates, a gate driving circuit 410, a data driving circuit 420, and a light emitting diode (LED) matrix 460. The LED matrix 460 includes a plurality of red LEDs 461, a plurality of green LEDs 462, and a plurality of blue LEDs 463.

The first substrate includes a number n (where n is a natural number) of gate lines 401 that are parallel to each other and that each extend along a first direction, and a number m (where m is also a natural number) of data lines 402 that are parallel to each other and that each extend along a second direction orthogonal to the first direction.

The gate lines 401 are driven by the gate driving circuit 410. The data lines 402 are driven by the data driving circuit 420. The gate lines 401 and the data lines 402 cross each other, thereby defining a plurality of pixel regions 405. The first substrate also includes a plurality of pixel electrodes (not shown) disposed in the pixel regions 405, respectively.

The first substrate further includes a plurality of thin film transistors (TFTs) 450 disposed in the pixel regions 405, respectively. The TFTs 450 function as switching elements. Each TFT 450 is provided in the vicinity of a point of intersection of a corresponding gate line 401 and a corresponding data line 402. Each TFT 450 includes a gate electrode (not labeled), a source electrode (not labeled), and a drain electrode (not labeled).

The gate electrode of the TFT 450 is connected to the corresponding gate line 401. The source electrode of the TFT 450 is connected to the corresponding data line 402. The drain electrode of the TFT 450 is connected to the corresponding pixel electrode.

FIG. 5 is a graph showing a light transmitting ratio of each pixel region 405 varying according to a voltage of a data signal applied to the pixel region 405. “T %” represents the light transmitting ratio of the pixel region 405. “V_{d}” represents a voltage of the data signal applied to the pixel electrode of the pixel region 405.

FIG. 6 is a graph showing abbreviated voltage waves of a plurality of driving signals generated by the gate driving circuit 410 and the data driving circuit 420. “Gₗ-Gₙ” represent scanning signals applied to the gate electrodes of the TFTs 450 via the gate lines 401. “V_{d}′” represents data signals applied to the pixel electrodes via the data lines 402 and the TFTs 450. A method of driving the LCD device 40 includes the following steps:

A frame period is divided into three sub-frame periods. In the first sub-frame period t1, the LED matrix 460 generates red rays. The gate driving circuit 410 generates a plurality of scanning signals, and applies the scanning signals to the gate lines 401. The scanning signals are high voltages. The high voltages turn on the TFTs 450. Thus, the data driving circuit 420 applies data signals to the pixel electrodes via the data lines 402 and the TFTs 450. A gray scale of the red rays in each pixel region 405 is controlled by a value of the corresponding voltage applied to the pixel electrode.

In the second sub-frame period t2, the LED matrix 460 generates green rays. The gate driving circuit 410 generates a plurality of scanning signals, and applies the scanning signals to the gate lines 401. The scanning signals are high voltages. The high voltages turn on the TFTs 450. Thus, the data driving circuit 420 applies the data signals to the pixel electrodes via the data lines 402 and the TFTs 450. A gray scale of the green rays in each pixel region 405 is controlled by a value of the corresponding voltage applied to the pixel electrode.

In the third sub-frame period t3, the LED matrix 460 generates blue rays. The gate driving circuit 410 generates a plurality of scanning signals, and applies the scanning signals to the gate lines 401. The scanning signals are high voltages. The high voltages turn on the TFTs 450. Thus, the data driving circuit 420 applies the data signals to the pixel electrodes via the data lines 402 and the TFTs 450. A gray scale of the blue rays in each pixel region 405 is controlled by a value of the corresponding voltage applied to the pixel electrode.

The red rays in the first sub-frame period t1, the green rays in the second sub-frame period t2 and the blue rays in the third sub-frame period t3 are mixed to form a color image.

However, the data lines 402 have some resistance, which causes errors of the data signals Vd. This leads to inaccuracies of the transmitting ratios T %, and further leads to inaccuracies of the gray scales of the red rays, green rays and blue rays. Accordingly, the display quality of the liquid crystal display device 40 is liable to be impaired.

It is desired to provide a new method of driving an LCD which can overcome the above-described deficiencies.

### SUMMARY

In one exemplary embodiment, a driving method is used to drive a liquid crystal display (LCD). The LCD device includes pixel regions, and a light source each including a pixel electrode. The driving method includes: dividing a frame period into at least three sub-frame periods, the light source emitting at least three different primary color rays in the at least three sub-frame periods respectively, and applying a data signal to each pixel electrode in each sub-frame period, the data signal comprising a constant high voltage and a constant low voltage, when the data signal is on high voltage, the corresponding primary color rays transmit through the corresponding pixel region at a constant transmission ratio, when the data signal is on low voltage, substantially no color rays transmit through. The duration of the corresponding primary color rays transmitting through the corresponding pixel region is controlled by a duty cycle of the data signal. The at least three different primary color rays, respectively, in the at least three sub-frame periods of a frame period are mixed to form a color image.

Other novel features and advantages will become more apparent from the following detailed description when taken in conjunction with the accompanying drawings, in which:

### BRIEF DESCRIPTION OF THE DRAWINGS

FIG. 1 is an abbreviated circuit diagram of a liquid crystal display (LCD) device according to an exemplary embodiment of the present invention, the LCD device including a gate driving circuit, a data driving circuit, a plurality of gate lines, a plurality of data lines, a plurality of thin film transistors, a plurality of pixel electrodes, and a light emitting diode (LED) matrix;

FIG. 2 is a graph showing a light transmitting ratio of each pixel region of the LCD device of FIG. 1 varying according to a voltage of a data signal applied to the pixel region;

FIG. 3 is a graph showing abbreviated voltage waves of a plurality of driving signals generated by the gate driving circuit and the data driving circuit of the LCD device of FIG. 1;

FIG. 4 is an abbreviated circuit diagram of a conventional LCD device, the LCD device including a gate driving circuit, a data driving circuit, a plurality of gate lines, a plurality of data lines, a plurality of thin film transistors, a plurality of pixel electrodes, and an LED matrix;

FIG. 5 is a graph showing a light transmitting ratio of each pixel region of the LCD device of FIG. 4 varying according to a voltage of a data signal applied to the pixel region; and

FIG. 6 is a graph showing abbreviated voltage waves of a plurality of driving signals generated by the gate driving circuit and the data driving circuit of the LCD device of FIG. 4.

### DETAILED DESCRIPTION OF PREFERRED EMBODIMENTS

Reference will now be made to the drawings to describe preferred and exemplary embodiments of the present invention in detail.

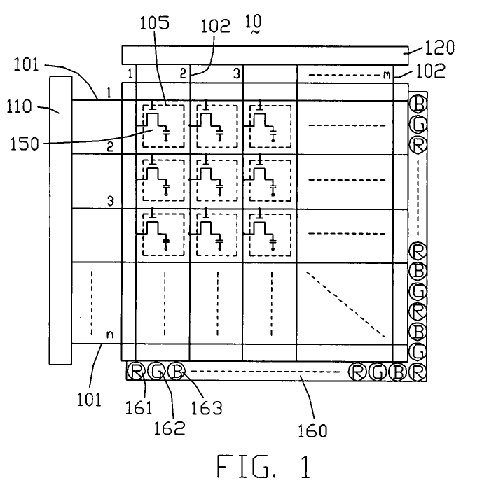

FIG. 1 is an abbreviated circuit diagram of an LCD device 10 according to an exemplary embodiment of the present invention. The LCD device 10 includes a first substrate (not shown), a second substrate (not shown) facing the first substrate, a liquid crystal layer (not shown) sandwiched between the two substrates, a gate driving circuit 110, a data driving circuit 120, and a light emitting diode (LED) matrix 160. The LED matrix 160 includes a plurality of red LEDs 161, a plurality of green LEDs 162, and a plurality of blue LEDs 163.

The first substrate includes a number n (where n is a natural number) of gate lines 101 that are parallel to each other and that each extend along a first direction, and a number m (where m is also a natural number) of data lines 102 that are parallel to each other and that each extend along a second direction orthogonal to the first direction.

The gate lines 101 are driven by the gate driving circuit 110. The data lines 102 are driven by the data driving circuit 120. The gate lines 101 and the data lines 102 cross each other, thereby defining a plurality of pixel regions 105. The first substrate also includes a plurality of pixel electrodes (not shown) disposed in the pixel regions 105, respectively.

The first substrate further includes a plurality of TFTs 150 disposed in the pixel regions 105, respectively. The TFTs 150 function as switching elements. Each TFT 150 is provided in the vicinity of a point of intersection of a corresponding gate line 101 and a corresponding data line 102. Each TFT 150 includes a gate electrode (not labeled), a source electrode (not labeled), and a drain electrode (not labeled).

The gate electrode of the TFT 150 is connected to the corresponding gate line 101. The source electrode of the TFT 150 is connected to the corresponding data line 102. The drain electrode of the TFT 150 is connected to the corresponding pixel electrode.

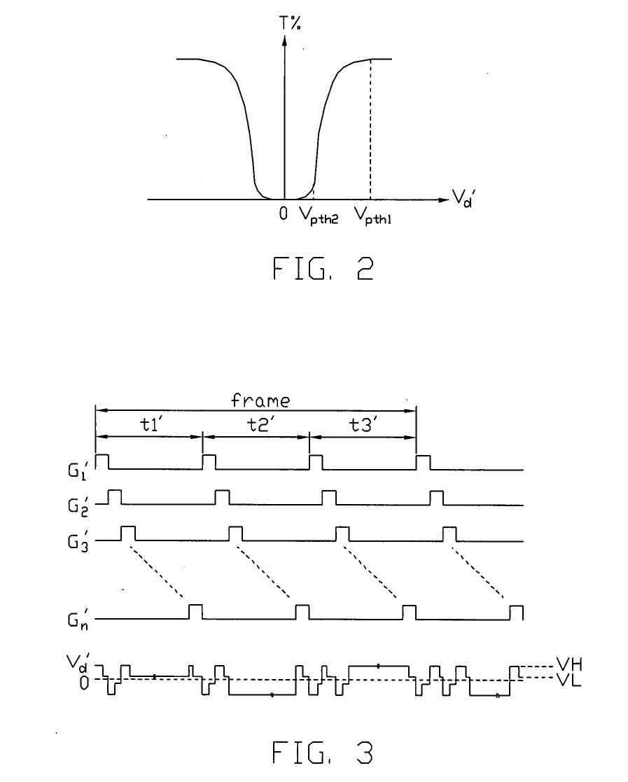

FIG. 2 is a graph showing a light transmitting ratio of each pixel region 105 varying according to a voltage of a data signal applied to the pixel region 105. “T %” represents the light transmitting ratio of the pixel region 105. “V_{d}” represents a voltage of the data signal applied to the pixel electrode of the pixel region 105.

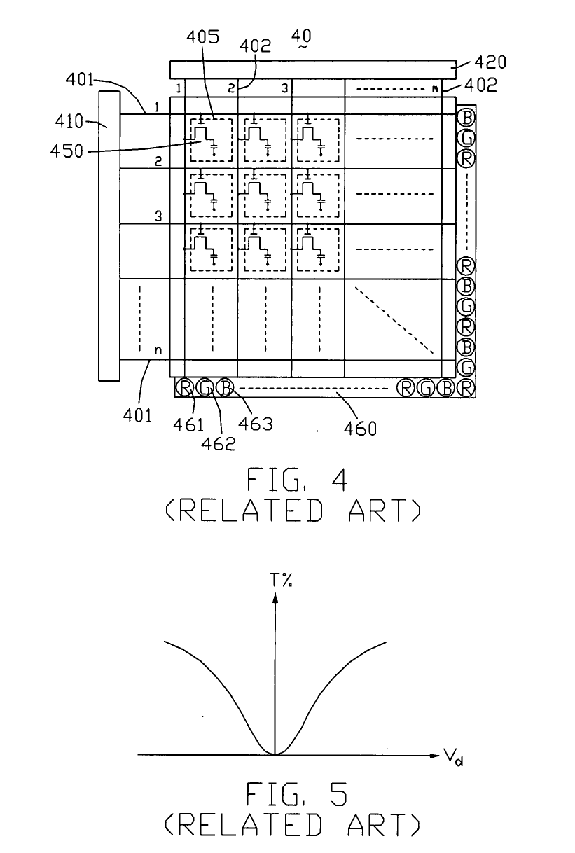

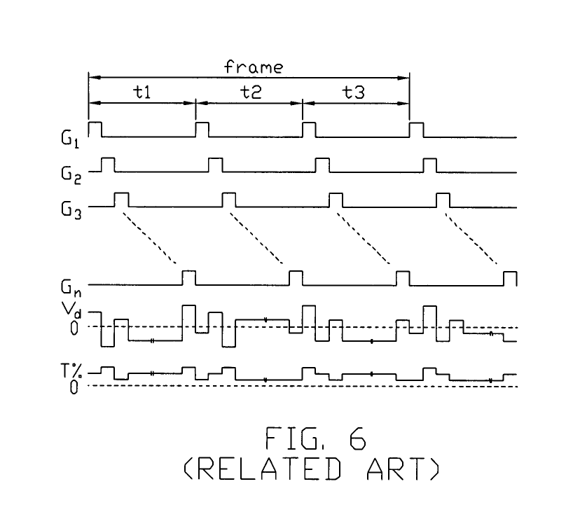

FIG. 3 is a graph showing abbreviated voltage waves of a plurality of driving signals generated by the gate driving circuit 110 and the data driving circuit 120. “Gₗ′-Gₙ′? represents scanning signals applied to the gate electrodes of the TFTs 150 via the gate lines 101. “V_{d}′” represents data signals applied to the pixel electrodes via the data lines 102 and the TFTs 150.

The data signals “V_{d}′” consist of a plurality of constant high voltages VH and a plurality of constant low voltages VL successively transmitted. When the data signal is on high voltage, light rays transmit through the pixel region 105, and the light transmitting ratio “T %” of the pixel region 105 is constant. When the data signal is on low voltage, no light rays transmit through the pixel region 105, and the pixel region 105 displays a black image. The proportion of the duration of the VH to the summation of the durations of the VH and the VL is defined as a duty cycle. A method of driving the LCD device 10 includes the following steps:

A frame period is divided into three sub-frame periods. In the first sub-frame period t1′, the LED matrix 160 generates red rays. The gate driving circuit 110 generates a plurality of scanning signals, and applies the scanning signals to the gate lines 101. The scanning signals are high voltages. The high voltages turn on the corresponding TFTs 150. Thus, the data driving circuit 120 applies data signals to the pixel electrodes via the data lines 102 and the TFTs 150.

When the data signal applied to each pixel electrode is on high voltage, the red rays transmit through the pixel region 105, and the red light transmitting ratio “T %” of the pixel region 105 is constant. When the data signal is on low voltage, no red rays transmit through the pixel region 105, and the pixel region 105 displays a black image. The proportion of the duration of the VH to the summation of the durations of the VH and the VL is defined as a duty cycle. Thus the duration of the red rays transmitting through each pixel region 105 is controlled by the duty cycle of the corresponding data signal applied to the pixel electrode.

In the second sub-frame period t2′, the LED matrix 160 generates green rays. The gate driving circuit 110 generates a plurality of scanning signals, and applies the scanning signals to the gate lines 101. The scanning signals are high voltages. The high voltages turn on the TFTs 150. Thus, the data driving circuit 120 applies data signals to the pixel electrodes via the data lines 102 and the TFTs 150.

When the data signal applied to each pixel electrode is on high voltage, the green rays transmit through the pixel region 105, and the green light transmitting ratio “T %” of the pixel region 105 is constant. The constant transmitting ratio “T %” has the same value as that in the foregoing first sub-frame-period t1′. When the data signal is on low voltage, no green rays transmit through the pixel region 105, and the pixel region 105 displays a black image. The proportion of the duration of the VH to the summation of the durations of the VH and the VL is defined as a duty cycle. Thus the duration of the green rays transmitting through each pixel region 105 is controlled by the duty cycle of the corresponding data signal applied to the pixel electrode.

In the third sub-frame period t3′, the LED matrix 160 generates blue rays. The gate driving circuit 110 generates a plurality of scanning signals, and applies the scanning signals to the gate lines 101. The scanning signals are high voltages. The high voltages turn on the corresponding TFTs 150. Thus, the data driving circuit 120 applies data signals to the pixel electrodes via the data lines 102 and the TFTs 150.

When the data signal applied to the pixel electrode is on high voltage, the blue rays transmit through the pixel region 105, and the blue light transmitting ratio “T %” of the pixel region 105 is constant. The constant transmitting ratio “T %” has the same value as that in the foregoing first sub-frame period t1′. When the data signal is on low voltage, no blue rays transmit through the pixel region 105, and the pixel region 105 displays a black image. The proportion of the duration of the VH to the summation of the durations of the VH and the VL is defined as a duty cycle. Thus the duration of the blue rays transmitting through each pixel region 105 is controlled by the duty cycle of the corresponding data signal applied to the pixel electrode.

The red rays in the first sub-frame period t1′, the green rays in the second sub-frame period t2′, and the blue rays in the third sub-frame period t3′ are mixed to form a color image in a frame period. The color images in all the frames form a dynamic picture that is viewed on a display screen of the LCD device 10.

A frame period is typically 16.7 milliseconds. The proportion of the first sub-frame period t1′ to a frame period, the proportion of the second sub-frame period t2′ to the same frame period, and the proportion of the third sub-frame period t3′ to the same frame period are adjustable, so that a white balance can be controlled.

As detailed above, in a conventional method of driving an LCD device, the value of the data signal applied to each pixel electrode in each sub-frame is controlled. Thereby, the LCD device controls the chroma of each pixel region in a frame. Further, the essential resistance of the data lines is liable to cause errors of the data signals Vd applied to each pixel electrode. This leads to inaccuracies of the chroma of each pixel region in a frame. Compare this with the above-described method of driving the LCD device 10, which is by means of controlling the duty cycle of the data signal applied to each pixel electrode in each sub-frame. Thereby, the LCD device 10 controls each primary color rays' duration of transmission in each pixel region 105 in a frame. Thus it is by means of controlling the duty cycle of the data signal applied to each pixel electrode in each sub-frame that the LCD device 10 controls the chroma of each pixel region 105 in a frame. Thus, the accuracy of the chroma of the image in each frame is high.

Further or alternative embodiments may include the following. In one example, the LED matrix generates the red rays, the green rays, and the blue rays in another sequence in a frame period. In another example, the LCD device 10 may include another kind of light source instead of an LED matrix. For example, the light source can be a plurality of cold cathode fluorescent lamps (CCFLs), which emit at least three primary color rays in at least three different sub-frame periods respectively.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of shape, size, and arrangement of parts) within the principles of the invention to the full extent indicated by the broad general meaning of the terms in which the appended claims are expressed.

What is claimed is:

1. A method of driving a liquid crystal display device, the liquid crystal display device comprising a plurality of pixel regions each comprising a pixel electrode, and a light source arranged for lighting the pixel regions with at least three different primary color rays, the driving method comprising:
dividing a frame period into at least three sub-frame periods, the light source emitting the at least three different primary color rays in the at least three sub-frame periods respectively; and
applying a data signal to each pixel electrode in each sub-frame period, wherein the data signal comprises a constant high voltage and a constant low voltage, and when the data signal is on high voltage, the corresponding primary color rays transmit through the corresponding pixel region at a constant transmission ratio, and when the data signal is on low voltage, substantially no color rays transmit through the corresponding pixel region; and
the duration of the corresponding primary color rays transmitting through the corresponding pixel region is controlled by a duty cycle of the data signal.

2. The driving method as claimed in claim 1, wherein the duty cycle is defined by a proportion of the duration of the high voltage to the summation of the durations of the high voltage and the low voltage.

3. The driving method as claimed in claim 2, wherein the at least three different primary color rays respectively transmitting through the corresponding pixel regions in the at least three sub-frame periods of a frame period are mixed to form a color image displayed by the liquid crystal display device.

4. The driving method as claimed in claim 3, wherein a chroma of an image displayed by the liquid crystal display device in a frame is controlled by the duty cycles of the data signals applied to the corresponding pixel electrodes.

5. The driving method as claimed in claim 3, wherein the light source comprises a plurality of light emitting diodes.

6. The driving method as claimed in claim 3, wherein the light source comprises a plurality of cold cathode fluorescent lamps.

7. The driving method as claimed in claim 1, wherein the at least three different primary color rays comprise red rays, green rays, and blue rays.

8. The driving method as claimed in claim 7, wherein the light source emits the red rays, the green rays, and the blue rays in that sequence in a frame period.

9. The driving method as claimed in claim 7, wherein the light source emits the red rays, the blue rays, and the green rays in that sequence in a frame period.

10. The driving method as claimed in claim 7, wherein the light source emits the green rays, the red rays, and the blue rays in that sequence in a frame period.

11. The driving method as claimed in claim 7, wherein the light source emits the green rays, the blue rays, and the red rays in that sequence in a frame period.

12. The driving method as claimed in claim 7, wherein the light source emits the blue rays, the green rays, and the red rays in that sequence in a frame period.

13. The driving method as claimed in claim 7, wherein the light source emits the blue rays, the red rays, and the green rays in that sequence in a frame period.

14. The driving method as claimed in claim 3, wherein a frame period is approximately 16.7 milliseconds.

15. The driving method as claimed in claim 1, further comprising adjusting a proportion of each of the at least three sub-frame periods to the frame period, so that a white balance of a corresponding image displayed by the liquid crystal display device is controlled.

16. A method of driving a liquid crystal display device, the liquid crystal display device comprising a plurality of pixel regions each comprising a pixel electrode, and a light source arranged for lighting the pixel regions with at least three different primary color rays, the driving method comprising:
dividing a frame period into at least three sub-frame periods, the light source emitting the at least three different primary color rays in the at least three sub-frame periods respectively; and
applying a data signal to each pixel electrode in each sub-frame period, wherein the data signal comprises a constant high voltage and a constant low voltage, and when the data signal is on high voltage, the corresponding primary color rays transmit through the corresponding pixel region at a constant transmission ratio, and when the data signal is on low voltage, substantially not at said constant ratio; and
the duration of the corresponding primary color rays transmitting through the corresponding pixel region is controlled by a duty cycle of the data signal.
